(19) United States
(12) Patent Application Publication
(10) Pub. No.: US 2012/0305542 A1
(43) Pub. Date: Dec. 6, 2012

(54) Oven Controlled MEMS Oscillator Device

(75) Inventors: Stephane Donnay, Herent (BE); Xavier Rottenberg, Kessel-lo (BE); Jonathan Borremans, Lier (BE); Hendrikus Tilmans, Maasmechelen (BE); Geert van der Plas, Leuven (BE); Michiel Pertijs, Delft (NL)

(73) Assignee: IMEC, Leuven (BE)

(21) Appl. No.: 13/150,499

(22) Filed: Jun. 1, 2011

(51) Int. Cl. A21B 1/02

(52) U.S. Cl. 219/412; 219/391

(57) ABSTRACT

A system is disclosed that includes an oven and a micromechanical oscillator inside the oven configured to oscillate at a predetermined frequency at a predetermined temperature, where the predetermined frequency is based on a temperature dependency and at least one predetermined property. The system further includes an excitation mechanism configured to excite the micromechanical oscillator to oscillate at the predetermined frequency and a temperature control loop configured to detect a temperature of the micromechanical oscillator using resistive sensing, determine whether the temperature of the micromechanical oscillator is within a predetermined range of the predetermined temperature based on the temperature dependency and the at least one predetermined property in order to minimize frequency drift, and adapt the temperature of the micromechanical oscillator to remain within the predetermined range. The system further includes a frequency output configured to output the predetermined frequency of the micromechanical oscillator.

### BACKGROUND

The present disclosure relates generally to systems comprising an oven controlled microelectromechanical system (MEMS) oscillator.

It is known that MEM systems and in particular MEMS resonators possess a very high quality factor (Q), and can be used to build oscillators, which makes them viable to serve as frequency reference devices, as illustrated in FIG. 1. Traditionally however quartz crystals are often used as a frequency reference because of their better temperature stability. When higher stability is required, as in broadcast transmitter systems, for example, an oven controlled crystal oscillator is often used. However, such quartz device is large and a system using a quartz reference suffers from a low level of integration. MEMS oscillators on the other hand are small, and can be integrated, thus lowering the cost significantly. However, MEMS resonators without compensation show a high sensitivity of frequency drift over temperature (e.g. +−5000 ppm over a 100° C. ambient temperature range), and thus have a less stable frequency characteristic over temperature than a quartz crystal, as illustrated in FIG. 2.

An MEMS resonator can be stabilized better over a wide ambient temperature range (e.g. a 100° C. ambient temperature range) by sensing the ambient temperature, and by compensating the MEMS resonator (e.g., electrically), depending on the measured temperature. FIG. 3 illustrates such a prior art solution. The ambient temperature is sensed by an external temperature sensor in good thermal contact with the MEMS device, and the MEMS oscillator system is compensated electrically by a frequency control means based on the measured temperature. In other words, an ambient temperature sensor drives a frequency compensation knob of the resonator system. In this way the MEMS resonator may typically be controlled up to +−100 ppm accuracy over a 100° C. ambient temperature range (e.g. from −20° C. to +80° C. ambient temperature).

A problem however with these mechanisms is the accuracy and temperature stability of the temperature sensors themselves. Their own drift over temperature limits the achievable temperature stability of the MEMS resonator, which is why a reliable (and expensive) temperature reference is often needed in such systems. Another limitation is the limited thermal contact between the resonator and the temperature sensor, which limits the possible achievable correction.

U.S. Patent Application Pub. No. 2009/0243747 uses two resonators in an oscillator configuration to generate one stable frequency, as shown in FIG. 4. Temperature stability is achieved by using two resonators having a different temperature coefficient of frequency, TCF=Δf/f.1/ΔT, which is the variation of the frequency per temperature variation, and by compensating for the frequency difference between the resonators due to temperature drift. A predetermined temperature Tₛₑₜ exists where both frequencies are identical (if no compensation was applied). The control loop compensates for the temperature variations and ensures the frequencies are maintained identical also for other temperatures. Therefore, stability of the resonator frequency is achieved. This concept however has the disadvantage of requiring two resonators with a different TCF, thereby requiring a lot of device-area. Also, both resonators should be configured as oscillators, requiring additional circuitry. Also, to achieve the desired frequency, the temperature at both resonator bars should be identical, which may be conceptually easy by matching the designs, but in practice very hard to guarantee. Finally, parasitic coupling between both devices results in a not so clean clock output.

### SUMMARY

Disclosed is an MEMS-based system for generating an output signal at a substantially stable frequency with which a reduced frequency drift can be achieved.

This aim is achieved according to the present disclosure with the system comprising the technical characteristics of the first claim.

In particular, it has been found that in order to minimize the frequency drift of the system, a ratiometric temperature control loop is needed, which is associated with said micromechanical oscillator and comprises components for detecting, evaluating and adapting the temperature of the micromechanical oscillator according to a ratiometric principle with resistive sensing, and which is furthermore provided for maintaining the temperature of the micromechanical oscillator within a predetermined temperature range around said predetermined set temperature, said predetermined temperature range being determined on the basis of said properties of said micromechanical oscillator and said temperature dependency of said frequency.

The system of the disclosure has the advantage that it is self-referenced, such that no external reference source for the temperature or the frequency is needed for its operation or to limit the frequency drift. Since only the relative temperature error needs to be detected (i.e., whether the actual temperature is greater or smaller than the desired temperature), no absolute measure of the amplitude of the error needs to be detected. Therefore, no amplifier or analog-to-digital converters are needed, which typically require highly accurate and stable characteristics over temperature. This greatly simplifies the system, rendering it more feasible. Gain errors in detection of the temperature error are irrelevant for achieving the desired Tₛₑₜ, since the relevant measure is simply ‘too high’ or ‘too low’, rather than a measure of how much too high or too low.

The system of the disclosure has the advantage that it can be low power, since the MEMS oscillator is located in the oven and thus shielded from the environment and furthermore since the need for a reference MEMS oscillator in the oven (like in dual resonator system described in US Patent Application Pub. No. 2009/0243747) can be avoided.

In some embodiments, the predetermined temperature range may be selected to be at most 0.10 ° C., which is possible with the ratiometric temperature control loop of the disclosure and which can reduce the frequency drift to only a few ppm or less.

The frequency or frequencies at which the micromechanical oscillator oscillates (the oscillator may be designed for oscillating in different modes or frequencies) is determined by the properties of the micromechanical oscillator, which comprise, among other things, the material in which it is constructed, its topology (e.g., shape and layout) and its dimensions.

A preferred material is silicon germanium, which has a TCF (temperature coefficient of frequency) of −40 ppm/° C. With the control loop of the disclosure and a predetermined temperature range restricted to 0.05° C., the frequency drift can be restricted to 2 ppm. On top of this, the design properties can be optimised to achieve an even better stability. As a result, with the ratiometric control loop with resistive sensing in combination with for example a silicon germanium oscillator, a frequency drift of 1 ppm or less can be achieved.

Another possible material is silicon, which has a TCF of −30 ppm/° C. In order to restrict the frequency drift to 2 ppm, a temperature range of 0.067° C. can be set in the control loop. Again, the drift can be further reduced by design on the properties of the oscillator. Note that the MEMS oscillator may also be constructed in other suitable materials as well.

In some embodiments, the MEMS oscillator may be a bulk acoustic resonator. Alternatively or additionally, the MEMS oscillator may be a surface acoustic resonator, a flexural resonator, or any other resonator.

In some embodiments, the micromechanical oscillator may be suspended by means of clamped-clamped beams, such as in a vacuum-sealed package, each beam comprising two support legs with a common connection to the MEMS oscillator. Using such beams as support anchors for the resonator has the advantage that thermal insulation of the resonator can be enhanced by, for example, making each leg of the beam acoustically long with respect to the flexural wavelength at which the beam oscillates as a result of the oscillation of the micromechanical oscillator (e.g., by making each leg longer than a multiple of the flexural wavelength). As a further advantage, it has been found that with such support anchors, power consumption of the single MEMS oscillator system can be below 1 mW, so that a power consumption for the whole system can be reduced to 10 mW or less. As a still further advantage, the length of the legs can be optimized in order to avoid affecting the quality factor of the oscillator.

In some embodiments, one or more of these beams can be used as heating resistance for heating the MEMS oscillator. In this manner, one or more of these beams may function as part of the control loop.

In other embodiments, the MEMS oscillator may be suspended by other types of support anchors as well.

The heating for the oscillator, as part of the control loop, may comprise a radiation source for heating the micromechanical resonator by means of radiation or any other heating mechanism.

The resistive sensing of the ratiometric temperature control loop may be provided by placing two sensing elements in sufficiently good thermal contact with the micromechanical resonator, such that the two sensing elements experience substantially the same temperature as the resonator. The ratiometric principle can be provided in that both sensing elements have different temperature dependent characteristics such that when measured the measurement curves intersect in a predefined intersection point corresponding to the predefined set temperature Tₛₑₜ. In this way, it is possible to easily determine if the actual temperature of the MEMS oscillator is above or below or equal to predetermined temperature Tₛₑₜ, and to control the loop acordingly. In some embodiments, a first sensing element may be sensed with a first sensing signal and a second sensing element may be sensed with a second sensing signal. In some embodiments, the first and second sensing signals may have substantially the same amplitude. In some embodiments, the first and second sensing signals may not have the same sign or phase or duration.

In one embodiment, the control circuit may be configured to substrate the first and the second sensing signals to thereby determine a difference signal. The control circuit may be further configured to amplify the difference signal, thereby generating a control signal.

In some embodiments, the control circuit may be connected to a post-compensation circuit configured to remove residual errors in the control signal, thereby generating a post-compensation signal. The post-compensation signal may be determined using, for example, a linear, quadratic, or polynomial transformation of the control signal. Alternately or additionally, the post-compensation signal may be determined using, for example, a look-up table. Other examples are possible as well.

The post-compensation signal may be supplied to the control circuit as a bias signal or an offset signal in order to reduce the difference between the temperature of the integrated electrical component and the predefined temperature.

By using such a post-compensation circuit to remove residual errors, inaccuracies resulting from offsets, thermal latency, and/or other non-idealities may be further reduced.

### BRIEF DESCRIPTION OF THE DRAWINGS

The disclosure is further elucidated in the appending figures and figure description explaining several example embodiments of the disclosure. Note that the figures are not drawn to the scale. The figures are intended to describe the principles of the disclosure. Further embodiments of the disclosure can use combinations of the different features and elements of the different drawings.

FIG. 1 shows a typical MEMS resonator applied in an oscillator and filter.

FIG. 2 shows a plot of typical frequency drift over temperature of an oven-controlled quartz crystal and for an uncompensated MEMS resonator.

FIG. 3 shows a typical MEMS system.

FIG. 4 shows another typical MEMS system.

FIGS. 5A-E shows a top (5A-B) and cross-section (5C-D) views of and a vacuum package (5E) including an MEMS oscillator, in accordance with an embodiment. view of a typical MEMS oscillator structure, in accordance with an embodiment.

FIG. 6 shows an example MEMS system, in accordance with an embodiment.

FIGS. 7A-B show example measurement voltage signals corresponding to temperature dependent resistor values (7A), the difference between the example measurement voltage signals (7B), and an output of a comparison between the example measurement voltage signals, in accordance with an embodiment.

FIG. 8 shows an example MEMS system including a heater, in accordance with an embodiment.

FIG. 9 shows a first and a second temperature dependent characteristic, in accordance with an embodiment.

FIG. 10 shows an example MEMS system including a heater and a control loop, in accordance with an embodiment.

FIG. 11 illustrates the stability of an example output signal for an oven-controlled MEMS oscillator without dual sensor control, with dual sensor control, and with dual sensor and post-compensation control, in accordance with an embodiment.

FIG. 12 shows an example MEMS system including a heater and a control system in which the post-compensation signal is a bias voltage.

FIG. 13 shows an example MEMS system including a heater and a control system in which the post-compensation signal acts upon a phase locked loop.

FIGS. 14A-C shows displacement of an example oscillating MEMS oscillator, in accordance with an embodiment.

FIG. 15 shows a schematic drawing of a bulk acoustic longitudinal oscillator heated by radiation, in accordance with an embodiment.

FIG. 16 shows measurement data for a 100×100 μm SiGe oscillator showing the frequency change versus the incident light power on the resonator, in accordance with an embodiment.

FIG. 17 shows an example flexural resonator, in accordance with an embodiment.

FIG. 18 shows another example flexural resonator, in accordance with an embodiment.

FIG. 19 shows an example MEMS oscillator heated by joule heating via the supports, in accordance with an embodiment.

FIG. 20 shows an example MEMS oscillator on which two resistors with 4-point access lines have been laid to measure the resistance of the top portion of the MEMS oscillator, irrespective of the resistance and temperature of the access lines, in accordance with an embodiment.

### DETAILED DESCRIPTION

The present disclosure will be described with respect to particular embodiments and with reference to certain drawings but the disclosure is not limited thereto. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the disclosure described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting of only components A and B. It means that with respect to the present disclosure, the only relevant components of the device are A and B.

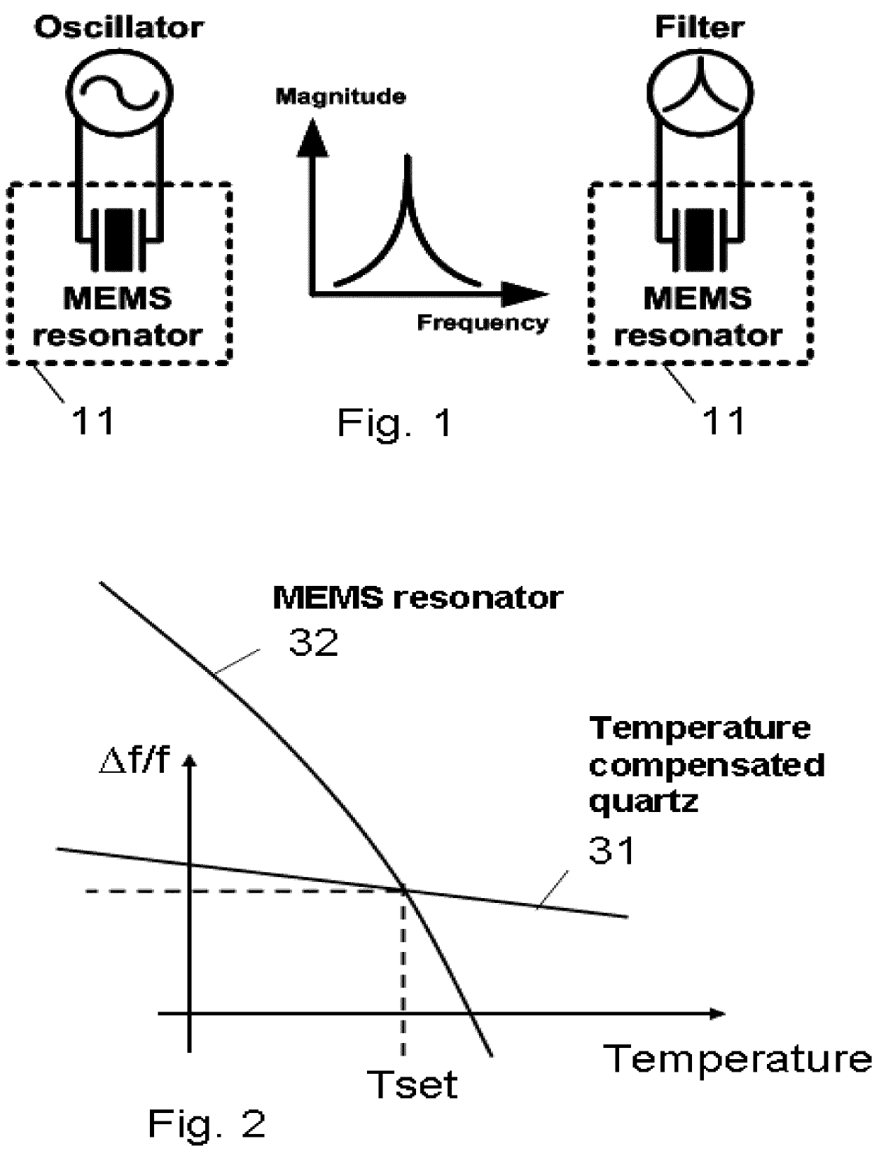

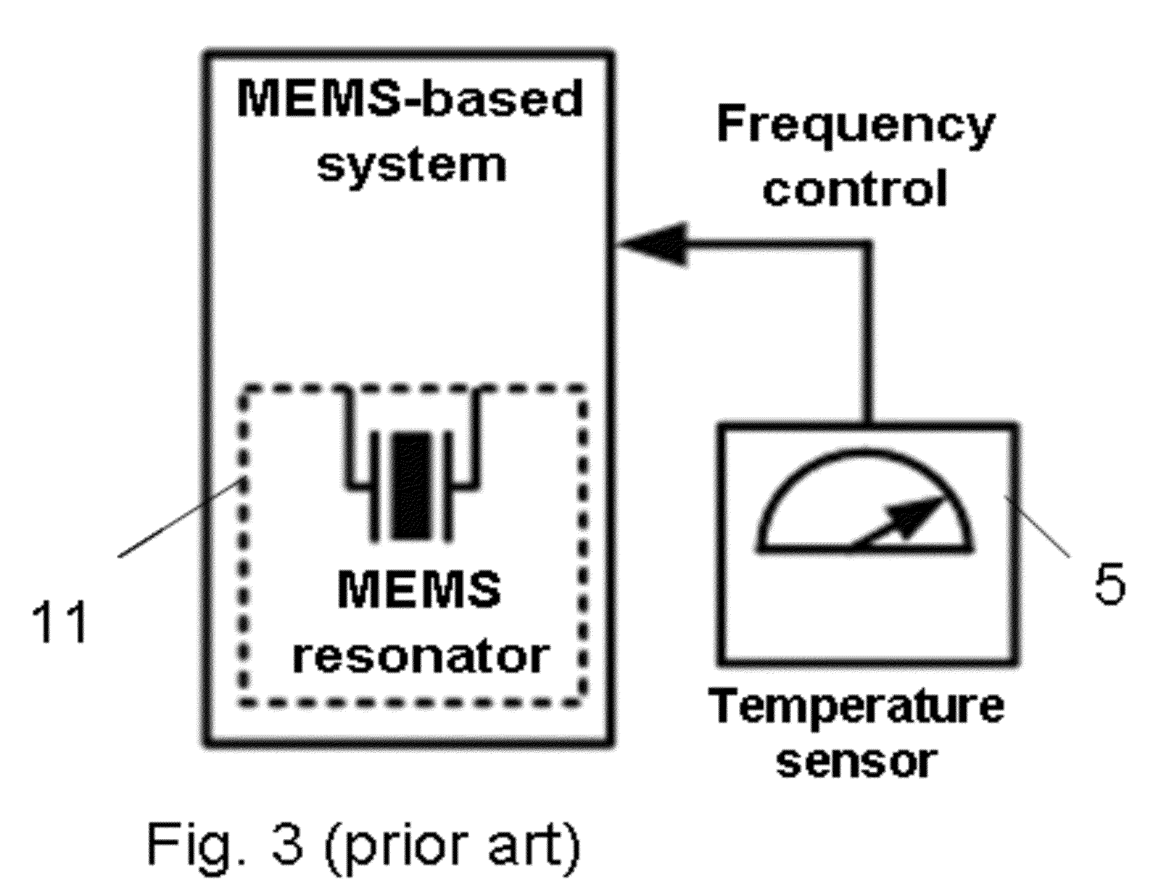

The present disclosure provides a system for stabilizing a temperature of a micro-electromechanical (MEMS) oscillator at a predefined temperature Tₛₑₜ. FIG. 1 shows a typical MEMS resonator applied in an oscillator and filter. The typical MEMS oscillator 11 may be used for a wide variety of applications, in some cases as pressure sensors, oscillators, and stress sensors. Because MEMS structures tend to be small, they can be integrated in many devices, including, for example, complementary metal-oxide-semiconductor (CMOS) chips.

One problem with typical MEMS structures like the MEMS oscillator 11, however, is that their characteristics may heavily drift with temperature. For example, in an MEMS oscillator, the frequency may drift with 5000 ppm in a 100° C. temperature range (e.g., from −20° C. to +80° C.). For example, a silicon-based MEMS oscillator typically has a −30 ppm/° C. sensitivity to temperature with respect to its resonance frequency fᵣₑₛ(T). It is said that its temperature coefficient of frequency (TCF) for such silicon-based MEMS oscillators is −30 ppm/° C.

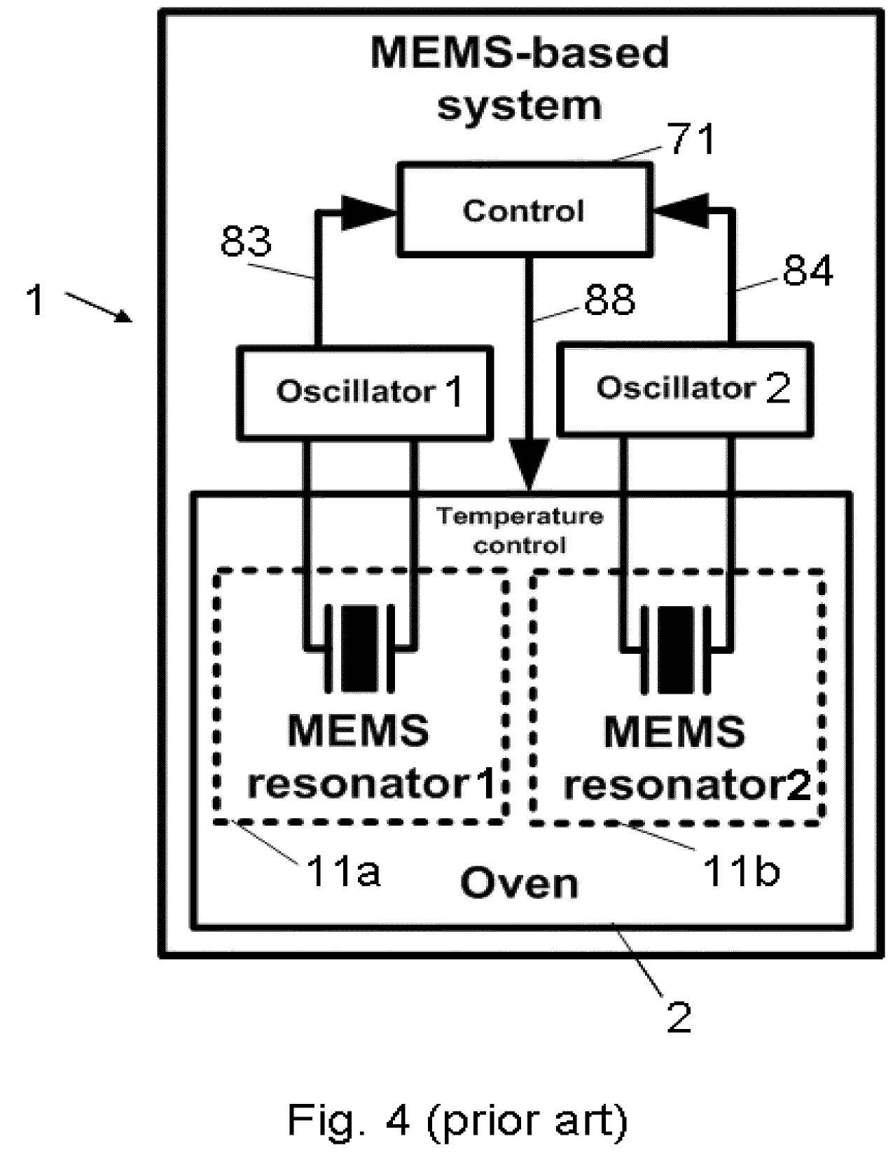

There are several techniques for stabilizing the frequency of an MEMS oscillator. In one technique, electrical compensation is used, in which the feedback signal of the oscillator circuit is modified to maintain a stable frequency. In another technique, the temperature T_{comp} of the MEMS oscillator is kept at a stable predefined temperature Tₛₑₜ. To this end, the MEMS oscillator may be placed in an oven, such as the oven 2 shown in FIG. 1, and the oven temperature Tₒᵥₑₙ may be maintained at the predefined temperature. This technique, however, typically requires some way of determining whether the temperature inside the oven is higher or lower than the predetermined value Tₛₑₜ. In U.S. Patent Application Pub. No. 2009/0243747, this determination is made using two MEMS resonators having a different TCFs (e.g., TCF1 and TCF2) and a control signal 88 is generated based on mixing the frequencies, as shown in FIG. 4.

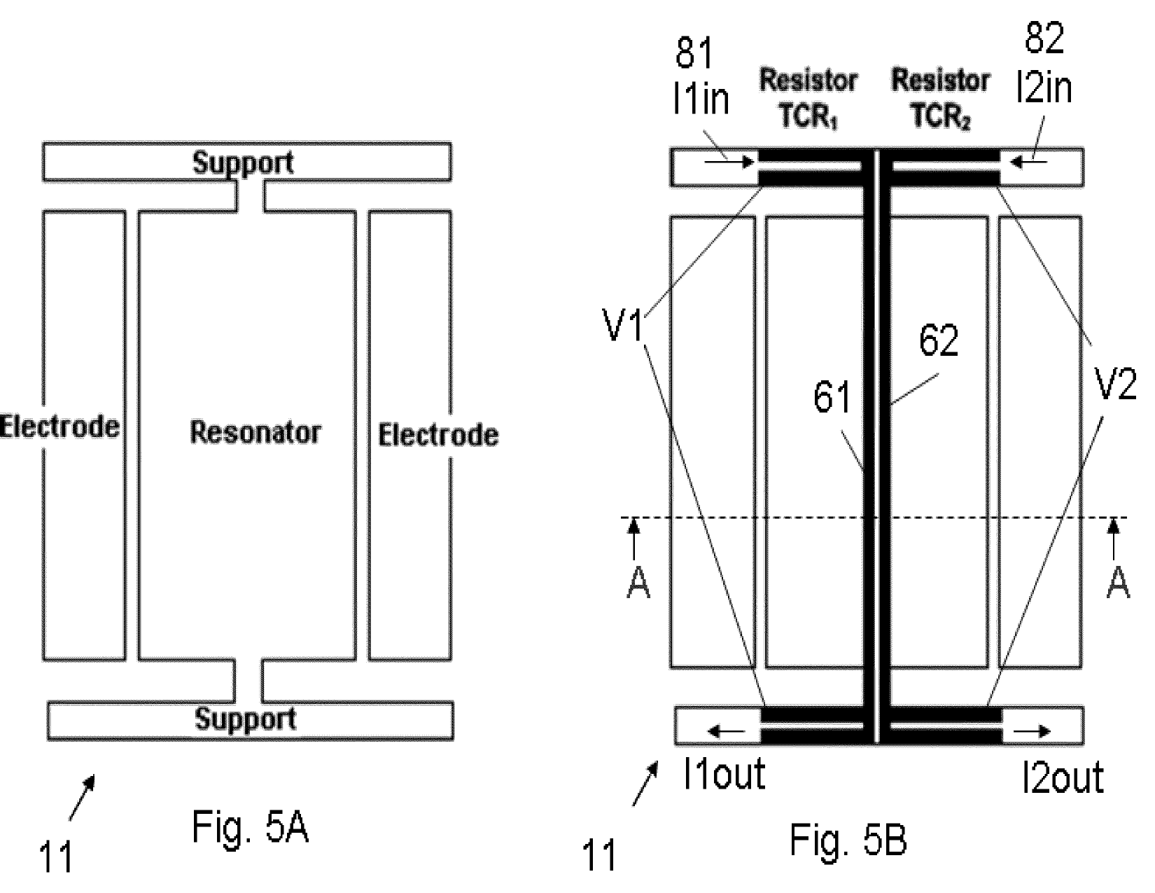

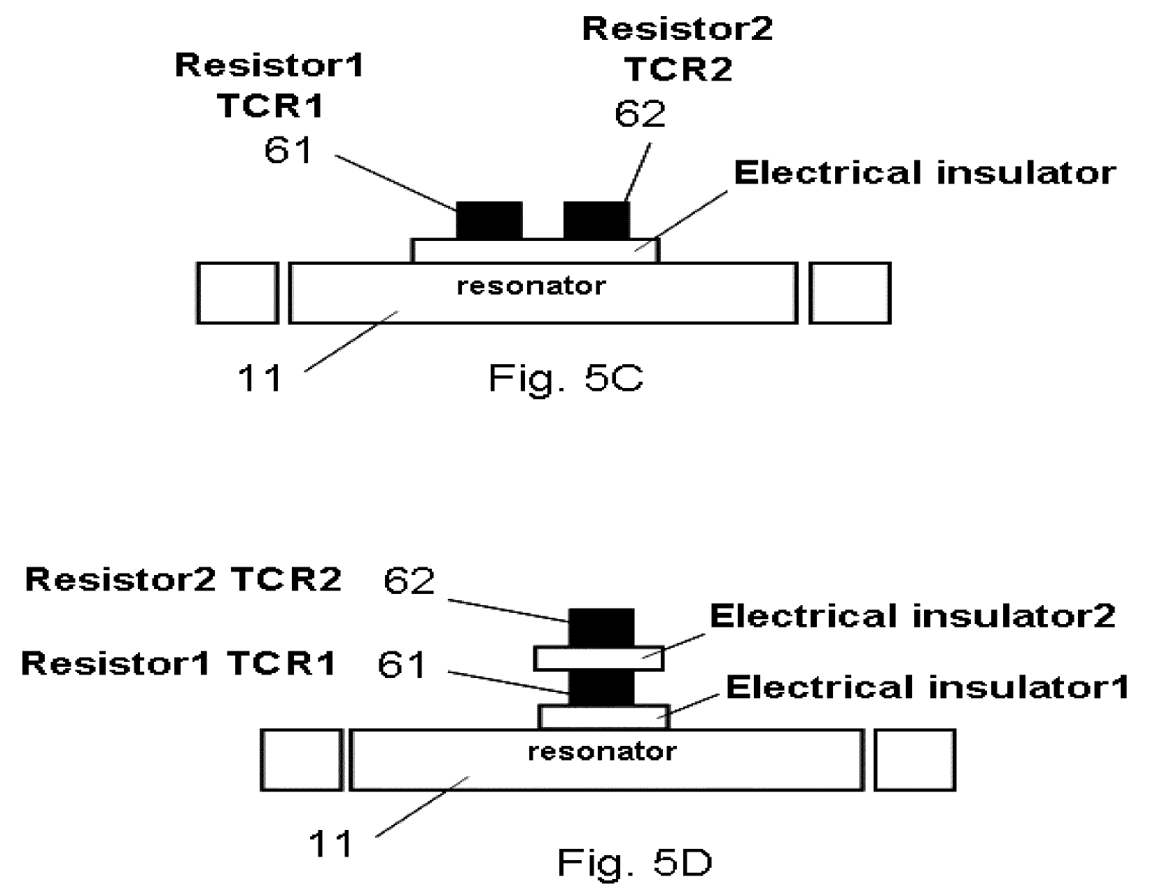

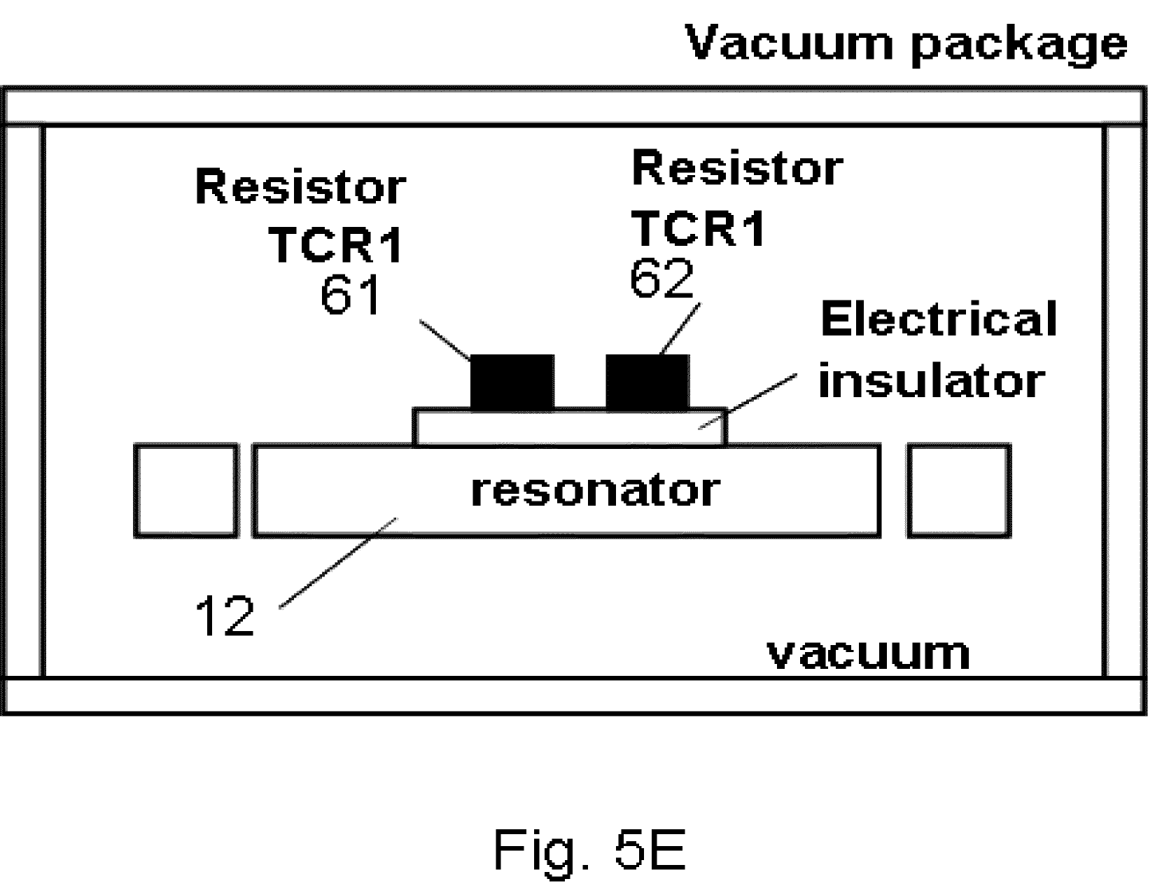

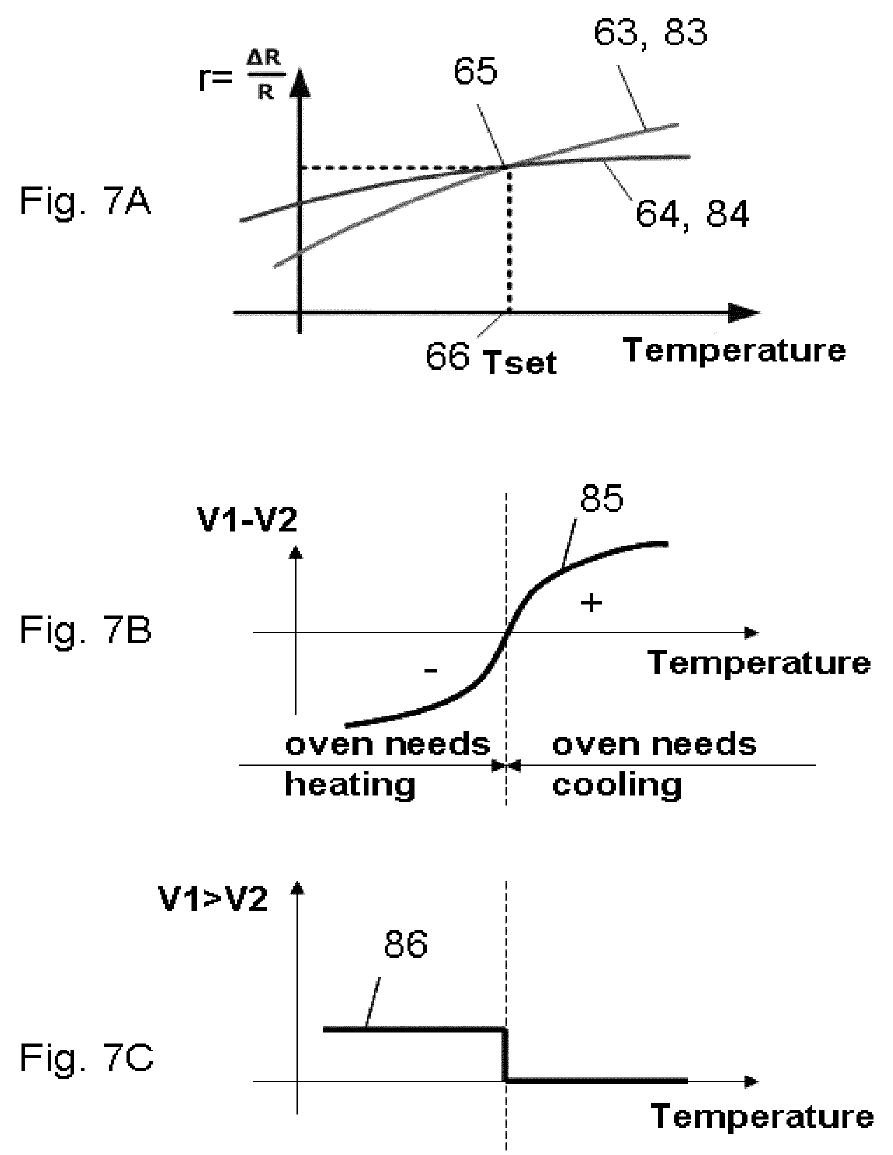

FIGS. 5A-E shows a top (5A-B) and cross-section (5C-D) views of and a vacuum package (5E) including an MEMS oscillator, in accordance with an embodiment. view of a typical MEMS oscillator structure, in accordance with an embodiment. As shown in FIG. 5B, the MEMS oscillator 11 includes a first resistor 61 having a first resistance r1 and a first temperature coefficient of resistance (TCR) TCR1. The MEMS oscillator 11 further includes a second resistor r2 having a second resistance r2 and a second TCR TCR2. The first resistor 61 and the second resistor 62 are shown to be processed on top of a resonator bar of the MEMS oscillator 11. The first resistor 61 and the second resistor 62 are electrically insulated from but in good thermal contact with the MEMS oscillator 11 so as to have desired thermal accuracy. The resistance values are chosen in combination with at least a first sensing signals 81 (11 in) and a second sensing signal 82 (12 in). The first sensing signal 81 may comprise, for example, a first direct current (DC) signal running through the first resistor 61. Similarly, the second sensing signal 82 may comprise a second DC signal running through the second resistor 62. The resistance values may be chosen such that resulting voltage curves, such as voltage curves 83, 84 shown in FIG. 7A, intersect in an intersection point 85 corresponding to the predefined temperature Tₛₑₜ. These resistors 61, 62 form an embodiment of the resistive sensing elements used in a ratiometric control loop according to the system of the present disclosure.

In one embodiment, the two sensing signals 81, 82 may be substantially the same. For example, each of the sensing signals 81, 82 may be DC signals generated by a current mirror. In another embodiment, each sensing signal (e.g., the first sensing signal 81) may be applied selectively to one sensing element (e.g., the first sensing element 62) using, for example, a switch, and a measurement signal (e.g. a first measurement signal 83) may be stored in a storage means, such as a measurement capacitor (not shown). After sensing, the measurement signals 83, 84 (e.g. voltages) stored on the storage means may be compared or subtracted for generating the control signal 88. In this way any differences between the first and the second sensing signals 81, 82 can be avoided.

Additional resistive elements besides the first and second resistors 61, 62 may be used as well, as long as intersecting temperature dependent characteristics 63, 64 can be obtained at the operating temperature, i.e. as long as the control loop remains “ratiometric.” Intersection can be created by simple scaling of the individual characteristics or other operations. For example, it is known that the resistance of a diode has a substantially exponential dependency on temperature, while the dependency of an electrical resistor is substantially linear, thus the temperature dependency is quite different. For simplicity the principles of the disclosure will be further described for resistors, though it is to be understood that other elements are possible as well.

Returning to FIG. 5B, in an embodiment the first and second sensing signals 81, 82 are generated by an electrical device 7. In some embodiments, the first and second sensing signals 81, 82 may be generated in the same chip that comprises the MEMS device 11. In another embodiment the sensing signals 81, 82 may be supplied from outside the electrical device 7, such as from outside the oven 2. The desired intersection point 65 (as shown in FIG. 7A) and the corresponding desired temperature Tₛₑₜ may be fixed or may be variable. In some embodiments, the desired intersection point 65 and the corresponding desired temperature Tₛₑₜ may be tunable by changing the sensing signals 81, 82. Allowing external sensing signals 81, 82 to be supplied may also allow for correction and/or calibration.

By placing the two resistors 61, 62 in thermal contact with the MEMS structure 11, in particular to the resonator bar, it is possible to make sure that the temperature T_{comp} of the resonator bar is as closely as possible matched to the predefined temperature Tₛₑₜ, during operation of the electrical device 7 (e.g., chip), thereby stabilizing the resonator frequency of this MEMS structure 11 as well as possible, as the resonator frequency is most sensitive to the local temperature of the resonator bar. Note that during the operation of the electrical device 7 there can be a temperature difference between the temperature inside of the oven Tₒᵥₑₙ and the temperature of the MEMS structure 11. Therefore, it may be desirable to place the sensing elements 61, 62 close to the MEMS structure 11.

FIG. 5C shows a cross section of the structure of FIG. 5B, where the sensing resistors 61, 62 are located on an electrical insulator which is placed on top of the resonator. In this way thermal contact without electrical insulation is achieved. FIG. 5D shows another embodiment according to the present disclosure. It will be clear to the person skilled in the art that many other topologies can be used.

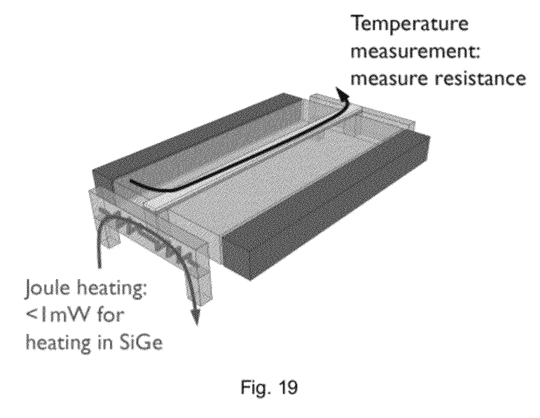

In an embodiment, the oven is a vacuum package 22 containing the MEMS oscillator 11 and a heating means 21. The package 22 provides thermal isolation from the MEMS device 11 to the ambient temperature on the outside of the vacuum package, and together with the heating means 21 forms the oven 2 or ovenized system 1. In a preferred embodiment, the MEMS element 11 can be heated by steering current trough its support legs, heating the MEMS device 11 through Joule heating (see FIG. 19). Any other type of heating means 21 can be used, as far as MEMS element 11 and the temperature sensing means 61, 62 are in good thermal contact, that is to say, have substantially the same temperature.

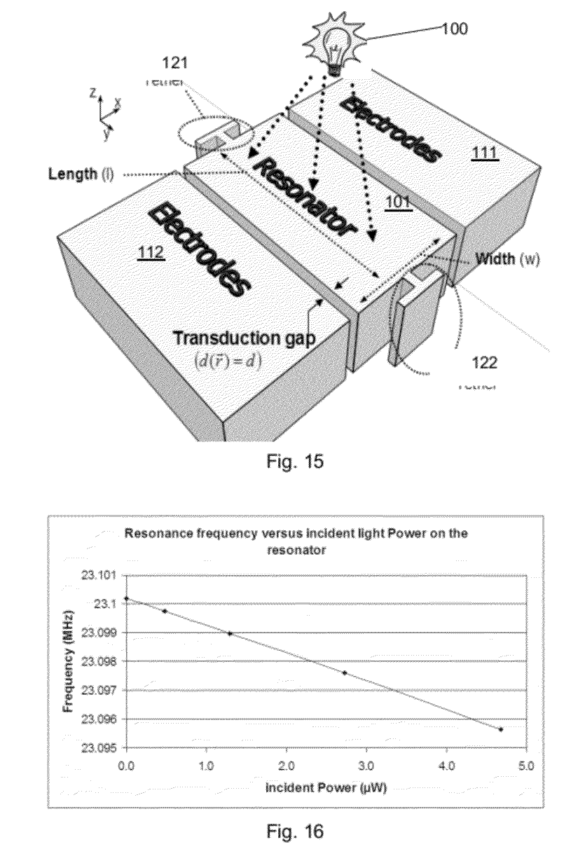

One other example is radiation heating, see FIGS. 15 and 16. In this embodiment, the heating means comprises a tunable thermal radiation source 100 and the MEM resonating element 101 is provided for absorbing thermal radiation generated by the tunable thermal radiation source. In other words, the MEM resonating element 101 is arranged for receiving thermal radiation emitted by the tunable thermal radiation source 100 while the control circuit is here arranged for monitoring a variation in the temperature of the MEM resonating element by means of resistive sensing elements (not shown), for example on top of the resonating element like in other embodiments described herein. A shift in temperature is monitored by the control circuit which adapts its output signal to the tunable thermal radiation source, for changing the amount of the emitted thermal radiation in relation to the monitored parameter value shift. This can be done by changing the intensity of the emitted thermal radiation, by switching the source on/off intermittently, or otherwise. By providing thermal energy in the form of thermal radiation, the thermal energy can be focused towards the MEM resonating element 101 thereby reducing or even avoiding directly heating the surroundings of the MEM resonating element. As the thermal energy can be more directly absorbed by the MEM resonating element, a much higher reaction speed of the device of the disclosure to temperature variations can be achieved. The light source 100 can for example be an integrated LED, whose intensity can be adjusted by controlling the LED current supplied to the LED.

Preferably, the resistive sensing elements 61, 62 are placed next to each other or above each other on top, below or next to the MEMS element 11, separated by electrically insulating but thermally conductive layers. Any other implementation providing good thermal contact and not severely deteriorating the MEMS element performance 11 can also be used.

The ratiometric principle may be achieved by using different TCR values, which may in turn be achieved by using two different materials for the resistors 61, 62 required for the dual sensor loop. FIG. 7A shows an example of the relative electrical resistance r=ΔR/R of the first and of the second resistors 61, 62 versus temperature T, or in general the temperature dependent characteristics 63, 64 of the first and the second sensing elements 61, 62.

The existence and production of electrical resistors having predefined TCR values is well known in the art. For example, the temperature coefficient of resistance TCR for n- or p-type silicon depends on the doping concentration, according to known formulas. A. Razborsek and F Schwager describe in “Thin film systems for low RCR resistors” how resistors comprising TaN overlayed with Nipads with adjustable TCR's between −150 ppm/° C. and +500 ppm/° C. can be produced. U.S. Pat. No. 7,659,176 describes tunable temperature coefficient of resistance resistors and method of fabricating same. The TCR value of a resistor may vary by using different materials, but resistors comprising the same materials but having different crystal structure or crystal orientation, or a different doping level or impurity level may also have different TCR values.

In the small, predetermined temperature range around Tₛₑₜ, the curves of the temperature dependent characteristics 63, 64 can be approximated by the formula:

R(T)=R₀(1+ΔT) (1)

where α is a material characteristic, called the temperature coefficient of resistance, known as TCR. While the term “resistor” is used, it is to be understood that parallel or series combinations of two or more individual resistors may be used as well to obtain a combined resistor with a combined resistance value r1 and a combined TCR1 value.

In an embodiment of the present disclosure using resistors as sensing elements, one of the TCR-values is substantially zero, while the other TCR value is positive. In another embodiment, one of the TCR-values is substantially zero, while the other TCR value is negative. In yet another embodiment, one of the TCR-values is negative while the other TCR value is positive. In still another embodiment, both TCR-values are negative but having a different value. In yet another embodiment, both TCR-values are positive but having a different value. Other TCR values are possible as well.

In an embodiment of the present disclosure, the first sensing signal 81 is an AC current, the second sensing signal 82 is a AC current, the first measurement signal 83 is an AC voltage and the second measurement signal 84 is an AC voltage. In another embodiment, the first sensing signal 81 is a DC current, the second sensing signal 82 is a DC current, the first measurement signal 83 is a DC voltage and the second measurement signal 84 is a DC voltage. In still another embodiment, the first sensing signal 81 is an AC voltage, the second sensing signal 82 is a AC voltage, the first measurement signal 83 is an AC current and the second measurement signal 84 is an AC current. In yet another embodiment, the first sensing signal 81 is a DC voltage, the second sensing signal 82 is a DC voltage, the first measurement signal 83 is a DC current and the second measurement signal 84 is a DC current. The sensing signals 81, 82 may be continuous signals or intermitted signals. The sensing and measurement signals may take other forms as well.

In an embodiment of the control circuit 71, the measurement signals 83, 84 (e.g. voltages) generated by the sensing elements 61, 62 (e.g. resistors) are subtracted and optionally amplified, yielding, for example, a difference signal 85 as shown in FIG. 7B (or the inverse thereof, depending whether the first measurement signal is subtracted from the second or vice versa). Optionally one of the measurement signals 83, 84 can be scaled before the subtraction. When the difference signal 85 is positive, the temperature T_{comp} of the MEMS oscillator 11 is higher than Tₛₑₜ, and the oven 2 should be cooled, which in the case of passive cooling may be achieved by not powering the heater 21. When the difference signal 85 is negative, the temperature T_{comp} of the MEMS device 11 is lower than Tₛₑₜ, and the oven 2 needs to be heated. In practice Tₛₑₜ may be chosen at least 10° C. above the ambient temperature, so that passive cooling can be used.

The actual heating power supplied to the heater 21 may, in some embodiments, be proportional to the amplitude of the difference signal 85, or may be quadratic, exponential, or another relationship. In other words, the control loop can, for example, evaluate the temperature T_{comp} of the MEMS oscillator 11 by comparing a temperature characteristic (e.g. resistance) of one temperature sensor 61 to a temperature characteristic (e.g. resistance) of a second temperature sensor 62. Via the temperature control loop, the oven temperature Tₒᵥₑₙ is driven to the temperature Tₛₑₜ where the characteristics intersect (difference of comparison result is zero), such that the output of the MEMS oscillator 11 is tuned to generate a substantially stable output signal. The predetermined temperature range in which the temperature Tₒᵥₑₙ is controlled around Tₛₑₜ determines the possible frequency drift of the output signal. By using the ratiometric loop with resistive sensing, the temperature range can, for example, be restricted to 0.10 ° C. around Tₛₑₜ, leading to a drift of a few ppm or less. The temperature range can be optimized (restricted) towards a target maximum frequency drift of, for example, 2 or 1 ppm by taking into account the properties of the MEMS oscillator 11 and the temperature dependency of the operating frequency.

In another embodiment, the measurement signals 83, 84 are compared to each other using, for example, a comparator (not shown), yielding, for example, a comparison signal 86 as shown in FIG. 7C. When the signal 86 of FIG. 7C is positive, the temperature T of the MEMS device 11 is lower than Tₛₑₜ, and the oven 2 should be heated. Depending on the comparator configuration, other comparison signals 86 may be generated, such as clipping to a positive or negative voltage, and the person skilled in the art can easily adapt such signal as required by the heating means 21, 100.

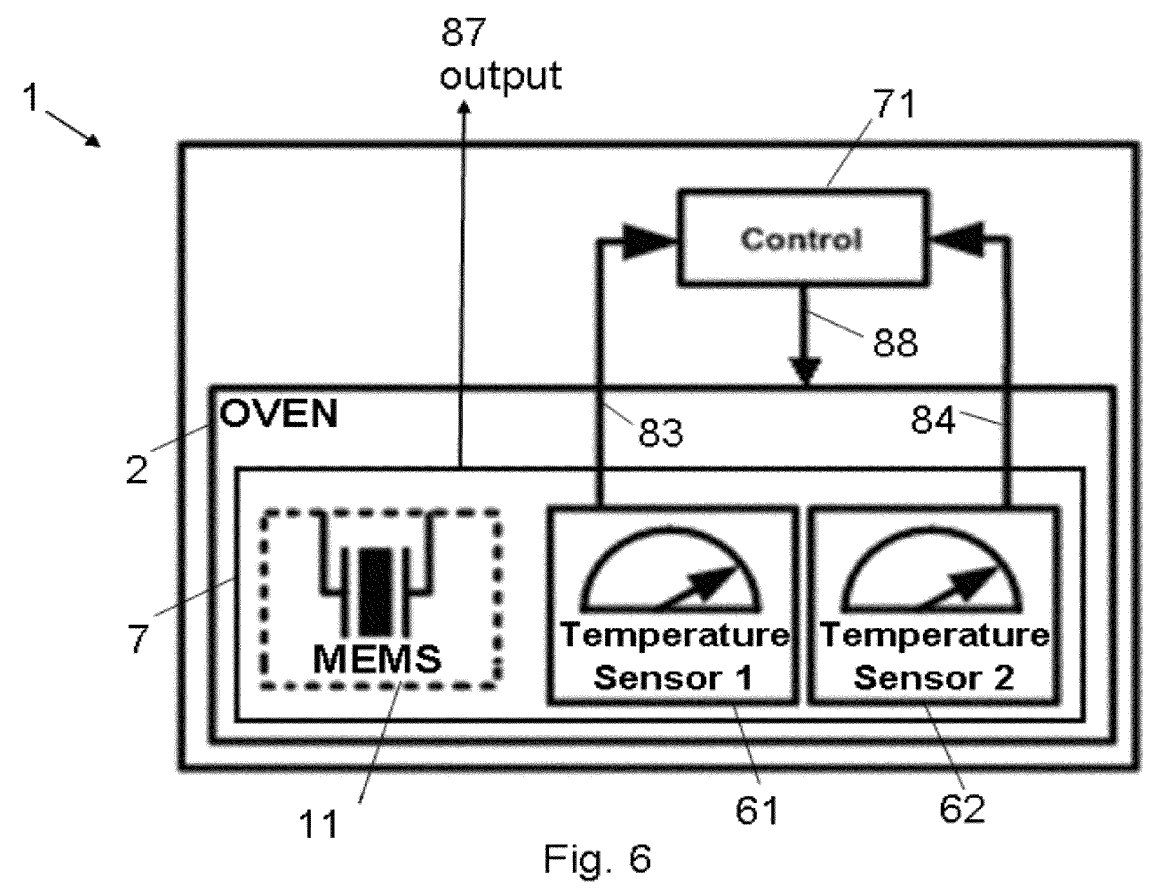

FIG. 6 shows an example MEMS system, in accordance with an embodiment. The control of the oven temperature Tₒᵥₑₙ is based on the ratio or difference of characteristics between two elements 61, 62. The system 1 comprises an oven 2 wherein an electrical device comprising an MEMS device is placed, the electrical device 7 comprising a MEMS structure 11 and two temperature sensors 61, 62 having different temperature dependent characteristics 63, 64 as explained above, such as two resistors R1 and R2 with TCR1 and TCR2 respectively. The system further comprises a control circuit 71 implementing a control loop for controlling or setting the temperature Tcomp of the MEMS structure 11, in particular of an element 11 thereof, to a fixed or desired temperature Tₛₑₜ. The control circuit 71 may be part of the electrical device 7 or part of the oven 2. The system operates as follows.

The variation of the resistance r of each resistor R1, R2 is illustrated in FIG. 7A and is noted as functions r1(T) and r2(T). Both resistances are a function of the temperature T. In the temperature range of consideration, there is one (and only one) point where r1(T) and r2(T) are equal. This point is defined by a predetermined temperature Tₛₑₜ. For this temperature: r1(Tₛₑₜ)=r2(Tₛₑₜ). This equation is only valid at Tₛₑₜ, the targeted oven temperature. A control loop controls the oven temperature such that r1(Tₛₑₜ)=r2(Tₛₑₜ). When this is realized, the temperature of the oven is Tₛₑₜ, and maintained at Tₛₑₜ. In fact, Tₛₑₜ lies at the intersection of the measurement curves 83, 84 which is the same as the intersection of the characteristic curves when the sensing signals 61, 62 are identical, otherwise the curves are a factor m shifted, m being the ratio of the amplitudes of the sensing signals 61, 62.

In steady state operation the temperature of the MEMS device 11 is maintained at Tₛₑₜ, and the temperature drift is substantially removed. If the control loop has infinite gain at DC (an integrator), this control loop can substantially achieve absolute average temperature accuracy in absence of other circuit non-idealities, such as temperature-dependent offset in the sensing circuitry.

The control loop 71 may be implemented in an analog or digital manner, using any algorithm known by the person skilled in the art. Additionally, the control loop 71 may provide a circuit for controlling and monitoring the MEMS structure 11 in the oven 2. The control loop can, in general, contain any element or mechanism needed to effectively operate the system 7 or to tune the output signal 87 (e.g., the frequency of the resonator of the MEMS structure in FIG. 6) as desired. In particular, the control loop will ensure that the temperature of the MEMS structure 11 is maintained at Tₛₑₜ. Signal quality factors and parameters of the MEMS structure 11 may also be recorded and/or monitored by the control loop. Factors such as thermal variations, noise, elasticity, stress, pressure, applied strain and electrical biases including voltage, electric field and current as well as resonator materials, properties and structure may affect the output of the MEMS structure 11. Monitoring these factors may be useful to develop a relationship between a resonator's output signal's contributing factors and the resonator's output signal characteristics. Understanding these relationships allows one to have more control over the generated output signal 87.

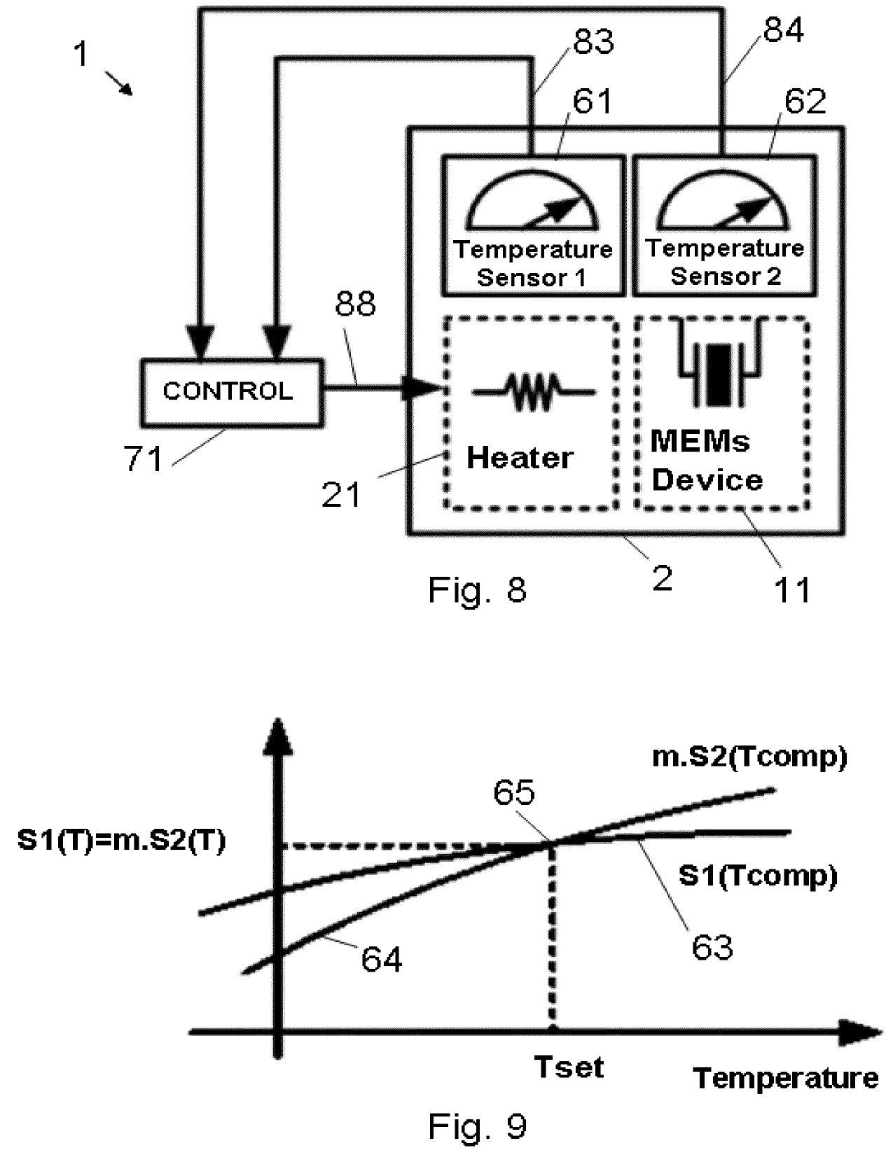

FIG. 8 shows an example MEMS system including a heater, in accordance with an embodiment. The purpose of the first and second sensing element 61, 62 and the control circuit 71 is to keeping the temperature inside the oven 2 stable, equal to Tₛₑₜ, regardless of the ambient temperature. As a result, the component parameter variations will be very small. Two temperature sensors 61, 62 sense the temperature of the MEMS component 11. The sensors 61, 62 have a different dependency on temperature. They output two temperature-dependent values S1 and S2, e.g. measurement voltages V1 and V2 as described above. The control loop 71 drives a heater 21 which controls the temperature Tcomp of the MEMS component 11. The control loop controls the oven temperature such that m*S2=S1, where m is a predefined constant real number. This equation is only valid at one single temperature Tₛₑₜ. Therefore, when the loop settles, the temperature of the component 11 is Tₛₑₜ, and thus its temperature-dependent parameters are stable. This is shown in FIG. 9, which shows a first and a second temperature dependent characteristic, in accordance with an embodiment.

It can be observed that the heater control signal 88 can be a function of ambient temperature T_{amb}. Indeed, assume that the ambient temperature drops, then the component temperature in the micro-oven 2 will drop too, due to the ambient temperature surrounding the oven 2. Therefore, both S1 and m S2 will change as well (they may increase or decrease, depending on the sign of the temperature dependency). This will trigger the control loop 71 to compensate the heater control signal 88 to heat up the oven 2 again to the targeted temperature Tₛₑₜ. Indeed, the loop will force m.S2 back equal to S1. It can be seen from this example that the control signal 74 is a function of the ambient temperature T_{amb}. Thus, the dual sensor temperature stabilizing loop 71 can be used as a temperature sensor.

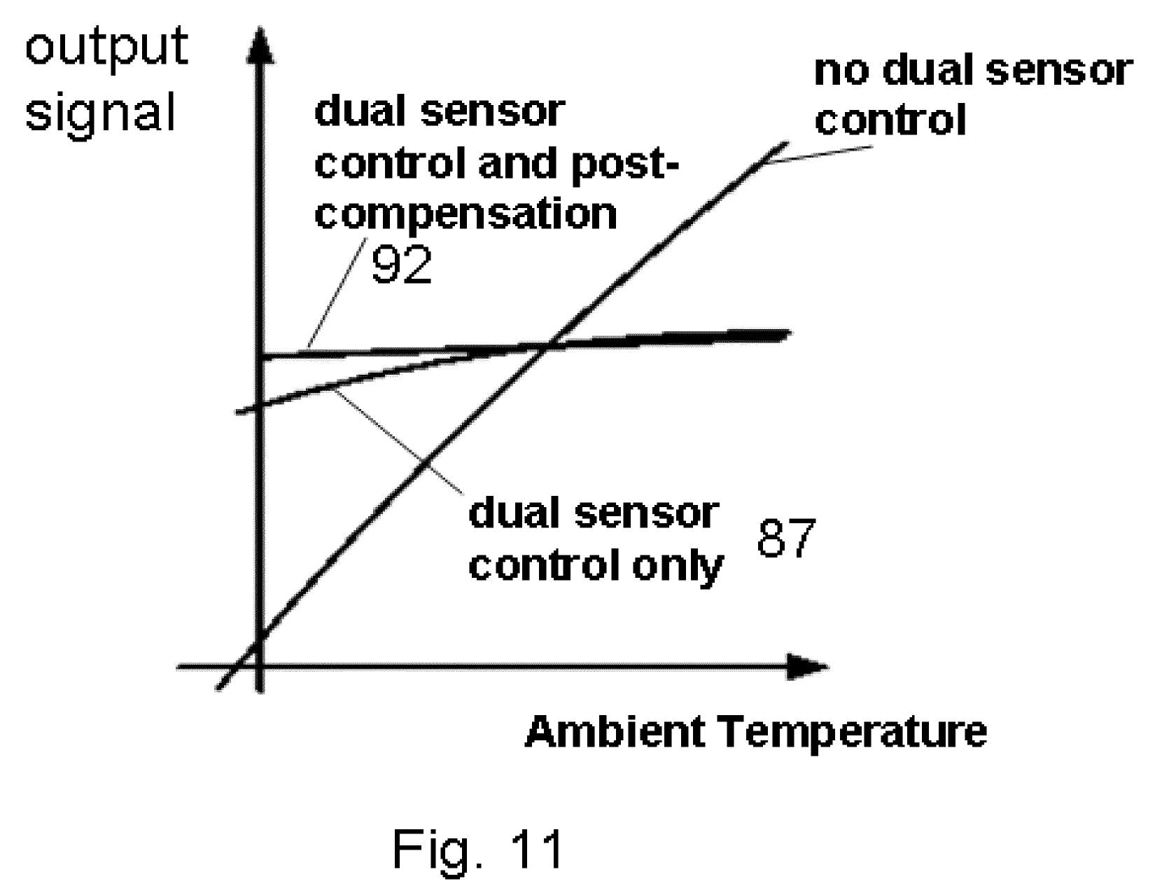

While the dual sensor control loop 71 shown in FIG. 8 is ideal, in real-world applications the dual sensor control loop 71 may suffer from non-idealities. This may result in a residual temperature dependency of the heated component parameters (e.g., frequency). In other words, while Tₛₑₜ is supposed to be fixed over ambient temperature variations, Tₛₑₜ may have a slight residual variation over ambient temperature, as shown in FIG. 11, which illustrates the stability of an example output signal for an oven-controlled MEMS oscillator with without dual sensor control, with dual sensor control, and with dual sensor and post-compensation control, in accordance with an embodiment (curve indicated by “dual sensor control only”). As shown, the component parameters may still change over temperature, which is undesired.

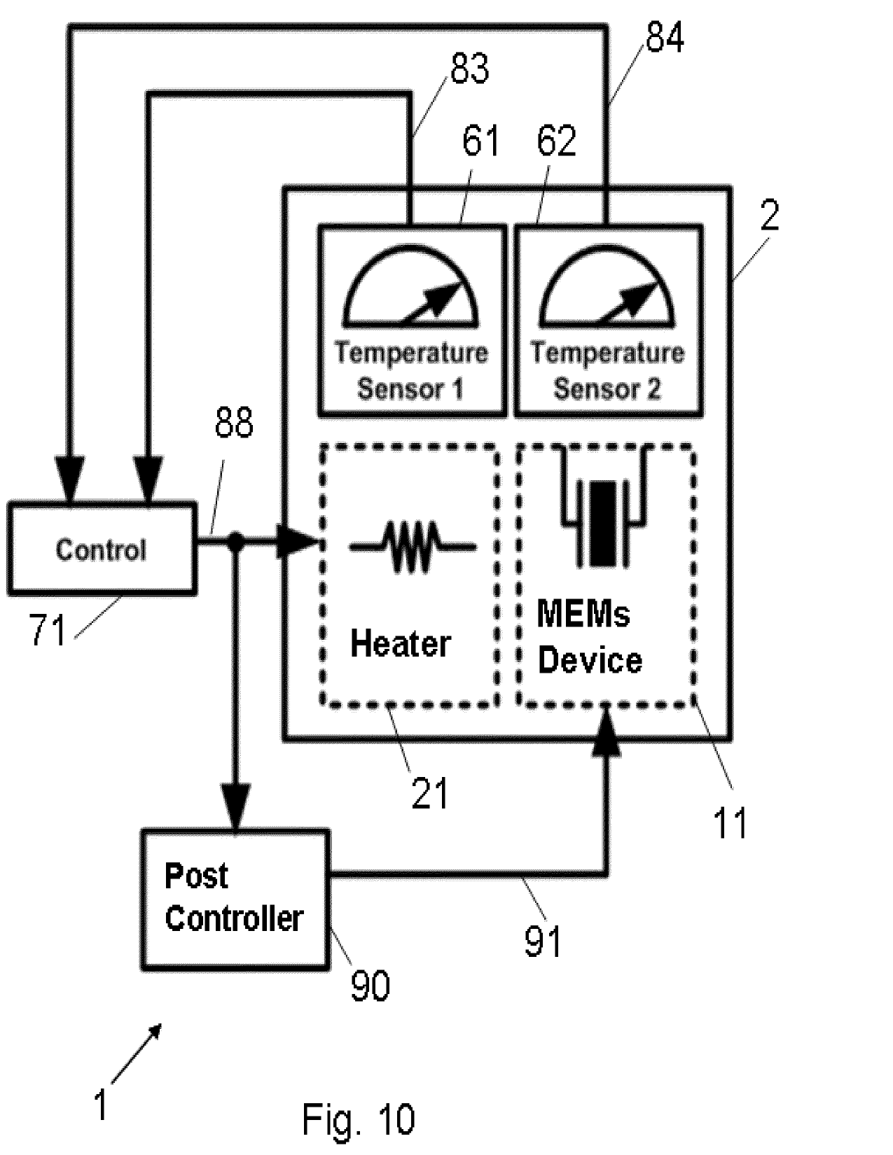

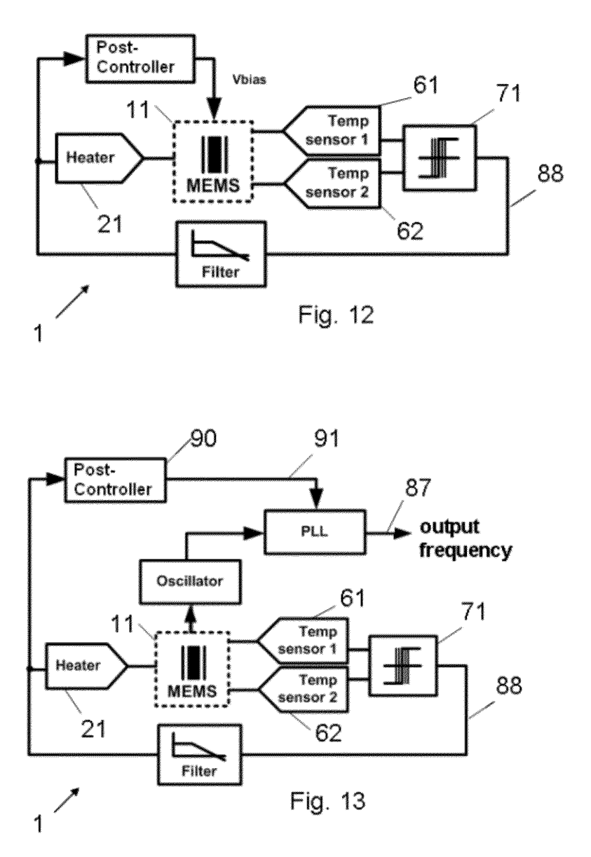

According to another aspect of the present disclosure, this residual temperature dependence may be further reduced by means of post compensation, as illustrated in FIG. 10, which shows an example MEMS system including a heater and a control loop, in accordance with an embodiment. In this approach, the ambient temperature T_{amb} needs to be sensed. The measurement of T_{amb} then steers a compensation scheme, which corrects the non-ideal components of the loop. Since the original residual temperature drift due to nonidealities is small, the measurement of T_{amb} does not need not to be very accurate. The post compensation scheme can be of any independent kind which can impact the parameters of interest (e.g., resonator frequency), but not the temperature. For example, the control signal 88, representative for the ambient temperature T_{amb} may steer a bias voltage of the MEMS component 11, as shown in FIG. 12, which shows an example MEMS system including a heater and a control system in which the post-compensation signal is a bias voltage.

FIG. 13 shows an example MEMS system including a heater and a control system in which the post-compensation signal acts upon a phase locked loop. The embodiment shown in FIG. 13 tunes a subsequent PLL which takes a MEMS oscillator as input and provides a tuned output frequency. This additional compensation 90 can be of any mathematic kind, such as linear, quadratic or polynomial, or based on a look-up table, or based on any other compensation known by the person skilled in the art. The operation of the post-compensation 90 and the effect on the component parameters or output parameter 92 (e.g. frequency) is illustrated in FIG. 11, which illustrates the stability of an example output signal for an oven-controlled MEMS oscillator without dual sensor control, with dual sensor control, and with dual sensor and post-compensation control, in accordance with an embodiment. As shown, the dual sensor control and post-compensation curve 92 is more flat than the curve 87 corresponding to the system without post-compensation 90.

As mentioned before, the dual sensor loop 71 may be implemented as an analog loop or a digital loop. Therefore, the ambient temperature output T_{amb} can be analog or digital, and the post-compensation scheme 90 can also be analog or digital.

While the post-compensation 90 can control an independent control signal (e.g., a bias voltage of the MEMS component 11), it can also act on a temperature loop component. The post-compensation scheme 90 may also act on external parameters, not part of the system. For example, the ambient temperature measurement can serve as post compensation in the external system using the component parameters. For example, the post compensation can be done in an external PLL which uses an ovenized MEMS-based oscillator.

Below, embodiments of MEMS resonator devices for use in systems according to the disclosure are described with optimal support anchoring for providing frequency and electro-mechanical stability and high Q-factor. The MEMS resonator devices shown in FIGS. 5, 15 and 19 each comprise a main resonator body of rectangular shape, but other shapes are possible (e.g. square, circular, parallelepiped, cube, etc). Excitation is achieved by means of electrodes 111, 112 placed at close proximity, i.e. at a transduction gap to the main resonator body 101. The body is suspended above the substrate by means of T-shape supports 121, 122 for anchoring the main resonator body to the substrate.

The T-shaped support or T-support comprises a clamped-clamped beam comprising two legs attached by means of anchors to the substrate, and a common, and in some cases central, connection to the main resonant body 101. The MEMS resonator structure 11 is configured to resonate at least in a predetermined mode, for example a breathing mode. The main resonator body resonates at a resonance frequency (fᵣₑₛ) related to its natural response. The length of the clamped-clamped beams or supports is chosen to be in relation to the flexural wavelength (type of wavelength dependent on most important stress component to support) for providing frequency stability and high Q factor. The T-support design utilizing a rigid clamped-clamped support provides electromechanical stability in the direction of actuation. More in particular, the length L_{Tsup} of each of the beam is chosen as a multiple of half the flexural wavelength plus an offset term.

In these embodiments, each beam is adapted for oscillating in a flexural mode at a given flexural wavelength as a result of said vibration of said resonator body at said operating frequency (fᵣₑₛ). This means that the properties of the beam are selected such that the beam is made to oscillate in the flexural mode (i.e. exhibits a low stiffness for this oscillation) as a result of the targeted vibration of the resonator body. It has been found that the ability of the beam to oscillate in the flexural mode can enhance or at least maintain electro-mechanical stability of the resonator while an understanding of the flexural mode can be used to optimize the beam design for other parameters. Furthermore each leg is “acoustically long” with respect to said flexural wavelength of the beam vibration, meaning the leg has a relatively long length with respect to prior art devices, which enhances the thermal insulation of the resonator body. As a result, the resonator can be heated to an operating temperature to keep the operating frequency substantially stable, without significant heat losses towards the substrate. The common central connection is preferably selected or designed to have a minimum length in view of electro-mechanical stability. The minimum length is determined by the design parameters and fabrication process.

Preferably, each leg has a length (L_{Tsup,opt}) equal to a predetermined multiple of said flexural wavelength divided by two, plus a predetermined offset, the predetermined multiple being selected in view of optimising thermal resistance of the leg and the predetermined offset being selected in view of optimising the quality factor of the resonator. By selecting one of these lengths for the support legs, the impedance at the connection point of the resonator and the impedance at the anchors are matched. As a consequence, the loss of energy to the substrate via the anchors can be minimized and a resonator device with optimized Q-factor can be provided. Preferably, the predetermined offset is substantially equal to half the length (L_{c1-c1,1}) of a clamped-clamped beam with first flexural resonance frequency equal to the operating frequency (fᵣₑₛ). It has been found that the Q-factor is a periodic function of the support leg length of the resonator and that this predetermined offset substantially corresponds to the maxima of the periodic function.

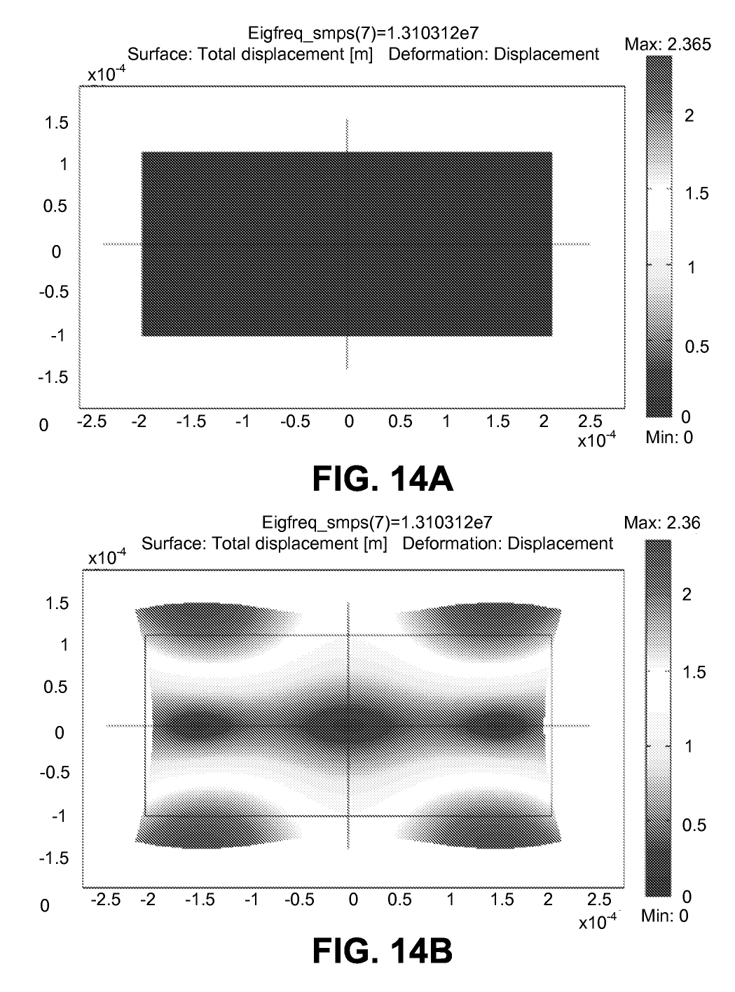

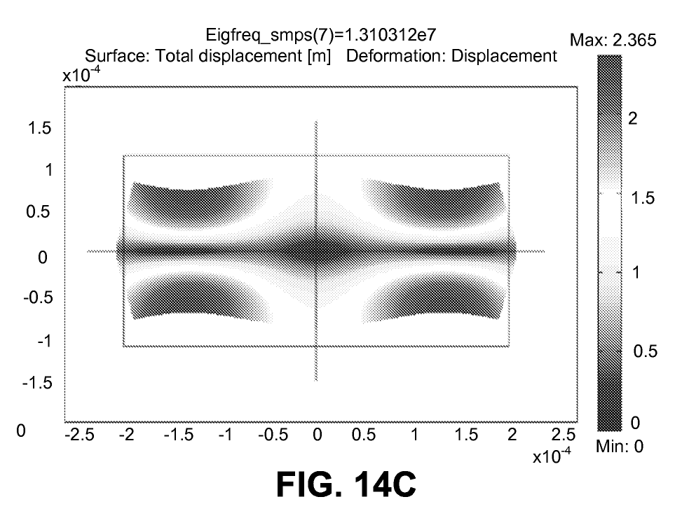

In preferred embodiments, the resonator body is adapted for resonating in a breathing mode which has a symmetry axis where displacement is minimal and wherein the common connections of the clamped-clamped beams are located at said symmetry axis. This means that the beams are connected to the resonator body at points of minimal displacement, which can enhance the electro-mechanical stability of the resonator. FIGS. 14A-C shows displacement of an oscillating MEMS resonator suitable for use in embodiments according to the disclosure. The resonator oscillates in a breathing mode, i.e. the body expands and contracts. FIG. 14A shows the main body in its original, flat shape, i.e. no displacement. FIG. 14B shows the displacement at the point of maximum expansion of the oscillation of the main body: there is substantially no displacement at the longitudinal (central) axis of the body, and maximal displacement along the longitudinal edges of the body. FIG. 14C shows the displacement at the point of maximum contraction of the oscillation of the main body: there is likewise substantially no displacement at the longitudinal axis of the body, and maximal displacement along the longitudinal edges of the body. This shows that this longitudinal axis is the best place to connect the supports for this oscillator in this breathing mode.

The high levels of electro-mechanical stability which can be achieved according to the disclosure further allows large voltages to be applied without the danger of pull-in, thus achieving lower motional impedance of the MEMS resonator which can lead to easier integration.

In preferred embodiments, the clamped-clamped beams are T-shaped, centrally connected to the resonator body. In alternative embodiments, the clamped-clamped beams can also be, for example, angled beams.

In preferred embodiments, the clamped-clamped beams have a rigid direction, said excitation means being located for exciting the resonator body in the rigid direction of said beams. For example, in the case of T-shaped beams, the rigid direction is the longitudinal direction of the support legs and the beams have a low stiffness in any direction orthogonal thereto.

The disclosure is, however, not restricted to micromechanical oscillators which are designed for oscillating in a breathing mode. Other operating modes are possible as well.

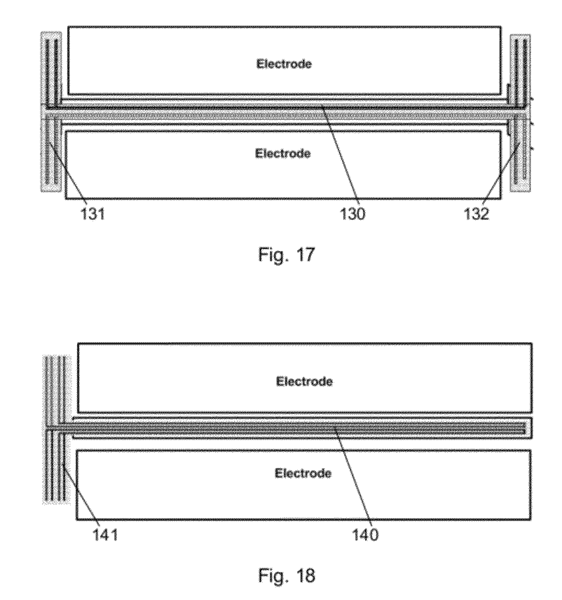

FIG. 17 shows an example of a flexural resonator which can be used in embodiments according to the disclosure. The resonator comprises a clamped-clamped beam 130 extending between two excitation electrodes and adapted for resonating in a flexural mode. The supports 131, 132 can in turn also be clamped-clamped beams with acoustically long legs as described herein. On top of the resonator, two resistive sensing elements are provided in the same way as has been described above in connection with FIG. 5.

FIG. 18 shows another example of a flexural resonator which can be used in embodiments according to the disclosure. The resonator comprises a cantilever beam 140 extending between two excitation electrodes and adapted for resonating in a flexural mode. The support 140 can in turn also be a clamped-clamped beam with acoustically long legs as described herein. On top of the resonator, two resistive sensing elements are provided in the same way as has been described with reference to FIG. 5.

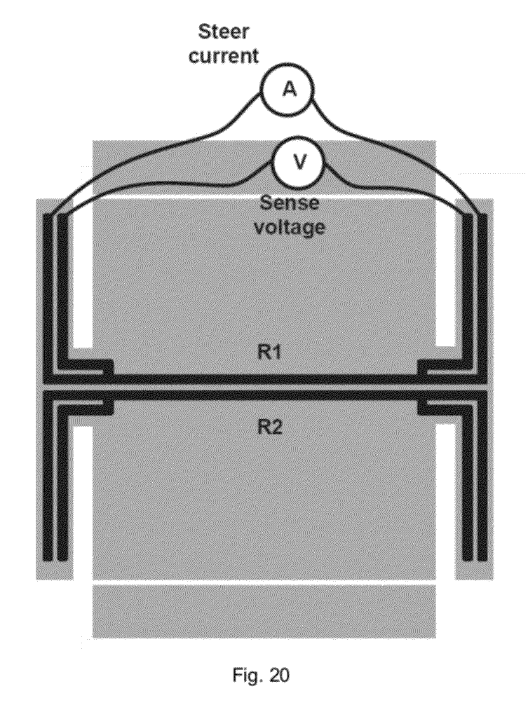

In another preferred embodiment, shown in FIG. 20, two resistors comprised of materials with different TCR are the sensing elements. Kelvin (4-point) connections to the resistor allow measurement of the resistance on the device. In a possible setup, a current A is steered through the resistor, while the voltage V is monitored. The resistance is then V/A, irrespective on the resistance and temperature of the access lines. Other sensing configurations can be applied as well.

1. A system comprising:
an oven;
a micromechanical oscillator inside the oven and configured to oscillate at a predetermined frequency at a predetermined temperature, wherein the predetermined frequency is based at least in part on a temperature dependency and at least one predetermined property;
an excitation mechanism configured to excite the micromechanical oscillator to oscillate at the predetermined frequency;
a temperature control loop configured to:
detect a temperature of the micromechanical oscillator using resistive sensing;
determine whether the temperature of the micromechanical oscillator is within a predetermined range of the predetermined temperature, wherein the predetermined range is based at least in part on the temperature dependency and the at least one predetermined property in order to minimize frequency drift; and
adapt the temperature of the micromechanical oscillator to remain within the predetermined range;
a frequency output configured to output the predetermined frequency of the micromechanical oscillator.

2. The system of claim 1, wherein the at least one predetermined property comprises a material of the micromechanical oscillator, a topology of the micromechanical oscillator, and at least one dimension of the micromechanical oscillator.

3. The system of claim 1, wherein the predetermined temperature range comprises temperatures within at most at most 0.10 ° C. of the predetermined temperature.

4. The system of claim 1, wherein the micromechanical oscillator comprises silicon germanium.

5. The system of claim 1, wherein the micromechanical oscillator comprises a bulk acoustic resonator.

6. The system of claim 1, wherein the micromechanical oscillator comprises a flexural resonator.

7. The system of claim 1, wherein the micromechanical oscillator comprises a surface acoustic resonator.

8. The system of claim 1, wherein the micromechanical oscillator is suspended using clamped-clamped beams, wherein each beam comprises two support legs with a common connection to the micromechanical oscillator.

9. The system of claim 8, wherein:
each beam is configured to oscillate in a flexural mode at a flexural wavelength, the flexural wavelength being based at least in part on the predetermined frequency; and
each leg is acoustically long with respect to the flexural wavelength.

10. The system of claim 9, wherein each leg being acoustically long with respect to the flexural wavelength comprises each leg being longer than a multiple of the flexural wavelength.

11. The system of claim 8, wherein at least one beam forms a heating resistance component of the control loop, the heating resistance component being configured to heat the micromechanical oscillator.

12. The system of claim 1, wherein the control loop comprises a radiation source configured to heat the micromechanical oscillator.

13. The system of claim 1, wherein the predetermined temperature is at least 10° C. above the ambient temperature of the system during normal use.

14. The system of claim 1, wherein the excitation mechanism comprises a biasing electrode inside the oven in close proximity to the micromechanical oscillator and connected to a bias voltage source.

15. The system of claim 1, wherein the frequency output comprises a sensing electrode inside the oven in close proximity to the micromechanical oscillator.

16. The system of claim 1, wherein the control loop comprises:
a first resistive sensing element in thermal contact with the micromechanical oscillator and having a first resistive temperature dependency; and
a second resistive sensing element in thermal contact with the micromechanical oscillator and having a second resistive temperature dependency that differs from the first resistive temperature dependency, wherein each of the first resistive element and the second resistive element experience substantially the same temperature as the micromechanical oscillator.

17. The system of claim 1, wherein:
the micromechanical oscillator has a topology with an axis of minimal movement during oscillation; and
the first and second resistive sensing elements are provided along the axis.

18. The system of claim 1, further comprising:
a post-compensation circuit for removing residual errors, the post-compensation circuit being configured to:
receive a control signal from the control loop; and
transform the control signal to generate a post-compensation signal.

19. The system of claim 1, further comprising:
an output signal generator connected to the frequency output and configured to generate an output signal based on the predetermined frequency.

20. The system of claim 1, wherein the oven comprises a vacuum-sealed package containing only the micromechanical oscillator.
